(19) United States
(12) Patent Application Publication
(10) Pub. No.: US 2020/0269623 A1
(43) Pub. Date: Aug. 27, 2020

(54) Methods of printing on non-permeable surfaces

(71) Applicant: Xyrec IP B.V., Schiphol-Rijk (NL)

(72) Inventors: Peter Boeijink, Schiphol-Rijk (NL); Matthew M. Robinson, San Antonio, TX (US); Paul T. Evans, San Antonio, TX (US)

(73) Assignee: Xyrec IP B.V., Schiphol-Rijk (NL)

(21) Appl. No.: 16/282,365

(22) Filed: Feb. 22, 2019

(51) Int. Cl. B41M 5/00; B41J 2/14

(52) U.S. Cl. CPC B41M 5/0011; B41J 2/14; B41M 5/0047; B41M 5/0058

(57) ABSTRACT

A method for forming an image on a non-permeable surface includes depositing a first layer of a solvent based composition on a non-permeable surface; partially curing the first layer; and printing a second layer of a solvent based composition on top of the first layer. The second layer can be a similar solvent based composition to the first layer, with the addition of one or more pigments.

### BACKGROUND

Ink jet printing is commonly used for precisely applying graphical images on paper or other surfaces. Different types of ink jet printing include continuous ink jet, thermal ink jet and piezoelectric ink jet printing. Typically, the ink is deposited onto paper or other permeable surfaces which allows for the ink to be at least partially absorbed by the surface and ensure the droplets stay and dry at the intended location to form the desired image.

Multi-color print systems typically have part of a print head, a single print head, or multiple print heads dedicated to printing a single color of ink. For example, a print system may have a single dedicated print head per color of ink where the first print head deposits red ink while the next deposits green and the next blue. The image is formed when very small colored droplets are deposited so close to one another that from a distance they appear to create a desired color.

When printing on nonpermeable surfaces, the ink drops may mix together and not maintain consistent shape or position in a repeatable fashion. This leaves an image that may be blurry or include undesirable changes in the observed color.

### SUMMARY

According to a first aspect of the invention, a method comprises depositing a first layer of a solvent based composition on a non-permeable surface; partially curing the first layer; and printing a second layer of solvent based composition on top of the first layer.

Such a method produces a sharp and desirable image. By depositing a first layer and allowing the first layer to partially, but not fully, cure before printing the second layer, the drops forming the second layer maintain a more consistent position with respect to other deposited drops. This produces a more desirable graphic image.

Optionally, the first layer is pigment free. Further optionally, the second layer comprises a pigment. For example, the first layer can be a composition with a set solvent and resin composition and transparent. The second layer can be a composition with a comparable solvent and resin composition to the first layer, and further including one or more pigments. The intermolecular forces driven through surface tension between the similar compositions ensure that the droplets stay in place while drying to form precise images with appropriate levels of edge sharpness for the specific application.

According to an embodiment, the second layer infiltrates the first layer at a rate of 0.5 microns or less. The infiltration rate affects how the resultant image appears to a viewer, as if the pigment granules are not at a uniform depth on the first layer, this can impact hue reproduction. By controlling the first layer thickness and partially curing the first layer, an appropriate infiltration rate for the droplets deposited can be achieved.

According to an embodiment, the step of partially curing the first layer comprises curing the first layer at 20-26 degrees C. for less than 24 hours. Optionally, this can be less than 8 hours. Further optionally, curing can be for less than 4 hours. Curing for less than 24 hours ensures that sufficient curing is achieved to have an appropriate surface for printing, and further ensures that full curing does not take place, which could adversely affect the printed image quality. Of course, specific curing times and temperatures may vary depending on the exact compositions used to ensure partial but not full curing.

According to an embodiment, the step of depositing a first layer of solvent based ink on a non-permeable surface comprises applying the first layer with a constant pressure air spray gun. Such an air spray gun can ensure an efficient and consistent first layer application. Further, an air spray gun can allow for a very thin layer, and one which can cure to appropriate levels very quickly, for example, within minutes. This can result in a very efficient process.

According to an embodiment, the step of depositing a first layer of solvent based composition on a non-permeable surface comprises applying the first layer with a thickness of 1-5 microns. Such a thickness provides for efficient curing, ensuring the first layer is ready for a deposition of the second layer very quickly.

According to an embodiment, the first layer and the second layer are applied with an automated process. Optionally, the application of the first layer and the second layer are performed with the same device. This can be, for example, with a robotic device which can perform an application over large and/or complex surfaces.

According to an embodiment, the first layer of solvent based composition is deposited on a coated base surface which has been fully cured. Optionally, the base surface is a metallic surface. This could be, for example, an aircraft body or another large vehicle.

According to an embodiment, the step of printing a second layer of solvent based composition on top of the first layer comprises printing the second layer with droplets in the range of 70-85 picolitres. Such droplet size can help to ensure that the droplets stay in place while drying due to the surface tension with the partially cured first layer.

According to an embodiment, the method further comprises using a background pulse in the print head and/or a spit process during the printing. Such processes can help to ensure accurate deposition of the droplets of the second layer.

According to an embodiment, the first layer and the second layer each comprise of a solvent based composition with a solvent weight percent of 65-95.

According to an embodiment, the step of printing a second layer of solvent based ink on top of the first layer comprises printing the second layer to be in the range of 1-10 microns. Such a thickness can ensure a quality image for a viewer.

### BRIEF DESCRIPTION OF THE DRAWINGS

The present invention will be discussed in more detail below, with reference to the attached drawings, in which:

FIG. 1 is a schematic view of a method of printing.

FIG. 2 depicts a schematic view of a substrate with a plurality of layers formed by the method of FIG. 1.

FIG. 3a shows a schematic embodiment of a print head suitable for use with the method.

FIG. 3b shows a schematic view of the bottom of the print head of FIG. 3a.

### DESCRIPTION OF EMBODIMENTS

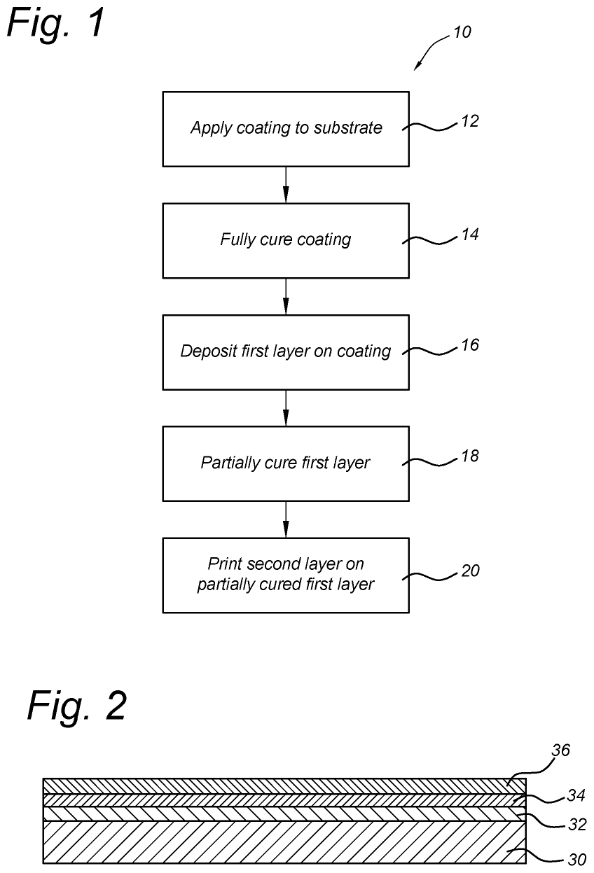

FIG. 1 is a schematic view of a method 10 of printing, and FIG. 2 depicts a schematic view of a substrate 30 with a plurality of layers 32, 34, 36 formed by the method of FIG. 1.

Substrate 30 can be any type of at least semi-rigid surface, for example, a three-dimensional metallic or composite surface. Substrate 30 can then be coated with any type of suitable coating, which will depend on the makeup of substrate 30 and the intended use (step 12).

Coating 32 can be applied in any way known in the art, for example, hand applied, rolled, sprayed, etc. Coating 32 can then be fully cured in step 14 such that a non-permeable surface is formed. The curing time and process will depend on the coating used. For example, if the coating 32 is a high quality, corrosion-resistant paint for high stress environments, the fully curing time required at ambient temperature is approximately twenty-four hours. Thus, such a coating could be cured at room temperature for 24 hours or more to ensure full curing. Other examples of coatings which could be used are solvent based coatings that are pigment/dye free and contain small amounts of acrylic resins.

Step 16 of depositing first layer 34 on the coated substrate 32 can involve various processes for applying first layer 34 onto coating 32. For example, a film spread process with the edge of a glass to ensure the appropriate thickness. Other spreading techniques could also be used, for example, with a bar and gage wire to set coating thickness. Further options for application include rolling, spray or even in some cases printing application. First layer 34 can be a solvent-based ink without pigment such that it is transparent. It could be the same formulation or a different formulation than second layer 36, for example, a primer of comparable solvent and resin composition to the subsequent, to be applied second layer 36, without pigment. The application in step 16 could be manual, robotic or a combination of the two. The thickness of first layer can be, for example, 1-5 microns, or 1-2 microns, though could vary in different applications.

Step 18 requires partial but not full curing of first layer 34 before printing second layer 36 in step 20. The partial curing process will vary depending on the composition of first layer but would typically consist of controlling the elapsed time between depositing the first layer 34 and applying the second layer 36. This would typically include ensuring a curing time of less than 24 hours at ambient temperature. In some cases, additional elements could be added to control the rate of curing, for example, heating or adding UV to first layer 34 to speed up the cure rate. Curing times could vary depending on the composition used, layer thickness, etc., and could be in the range of 15 minutes to 4 hours, 4-8 hours, 8-15 hours, or even up to 24 hours. The typical temperature would be about 20 degrees C. to 26 degrees C.

Fully cured primer coatings are those that exhibit adhesion test results comparable to base-coat paint performance. The adhesion test can be any acceptable industry standard, for example, the Standard Test Methods for Rating Adhesion by Tape Test set out in ASTM D3359. Fully cured surfaces typically result in further applied layers to appear non-uniform or uneven. By not fully curing, second layer 36 of the current process has a better, more clear and crisp appearance after application.

If an air spray gun is used for application of first layer 34 in step 16, it is possible that the partial curing (such that first layer is dry “to the touch”) may happen in minutes, thereby allowing the commencement of step 20 as soon as the application of first layer 34 is complete. The spray gun or other apparatus used to apply first layer 34 could be mounted on the same apparatus used to apply second layer 36 to ensure consistent application of first layer 34 and second layer 36. The application process (e.g., using a spray gun, rolling, etc.) allows for application of a very consistent thickness for first layer 34, allowing for a very thin application. This provides for more predictable, consistent curing times and a reliable thin base layer for the printing of second layer 36. The thin layer also allows for quick curing speed, enabling second layer 36 to be applied sooner and an overall more efficient process.

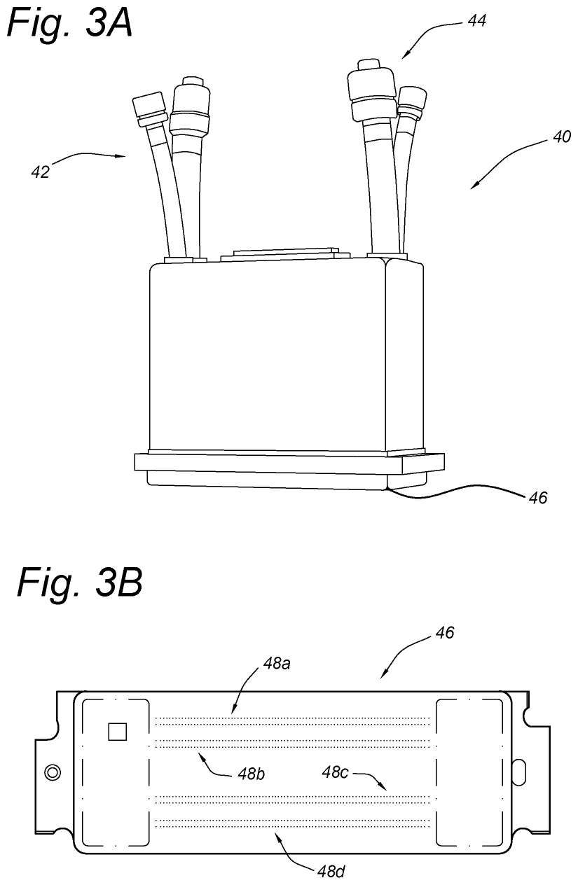

Second layer 36 is then deposited on partially cured first layer 34 by a printing process in step 20. Second layer 36 can be the same solvent based ink as first layer 34, only with pigment(s) added to form the desired image. The printing process can be performed with a print head (see FIG. 3) mounted on an end-of-arm tolling of a robot or other device, such as the robot found in U.S. application Ser. No. 16/015,236 file Jun. 22, 2018 and titled Robotic System for Surface Treatment of Vehicles, the contents of which is hereby incorporated by reference.

Suitable compositions for second layer 36 include a primer of comparable solvent and resin composition to the first layer, only including pigment(s). Suitable solvent based compositions would typically include a solvent weight percent of 65-95.

The drop size of the second layer 36 is precisely controlled such that it is sized to stay in place while drying due to the surface tension with partially cured first layer 34. The droplet size can be, for example, 70-85 picolitres, though could vary. Solvent based compositions allow for a smaller droplet size (than for example, polymer-based composition), allowing for a very rapid drying time. The intermolecular forces driven through surface tension ensure that the droplets stay in place through drying to form precise images with appropriate levels of edge sharpness required for the specific application. The typical thickness of second layer 36 would generally be about 1-10 microns, for example, 2-4 microns, 4-8 microns for very vibrant colors, and could vary depending on the composition, ink colors, etc.

The application of second layer in step 20 can also including a manipulation of the voltage in the printing process. Each color ink includes a modification of the reference optimized waveform to manage the granule size of the specific color of ink being printed. The waveform is typically developed for a target drop size and ink composition and is then modified for each color due to grain size variation and/or additive composition variation between colors. For example, printing 80 picolitre drops of yellow may require a different voltage to get an equivalent 80 picolitre drop of a cyan pigmented composition. This change in voltage typically includes a scaling of the waveform to run a portion of the nominal waveform depending on the color currently being used. This can be controlled by, for example, a controller connected to or interfacing with the printhead. A background pulse in the print head and/or a spit process at the end of a pass could also be used in the application of second layer 36 to ensure that print nozzles do not clog during printing (something that is more likely due to the quick drying solvent-based compositions).

Method 10 allows for printing images and/or colors on surfaces, for example three-dimensional surfaces, that are coated with a non-permeable coating. Adhesion and the ability to maintain consistent drop location and prevent mixing between drops has typically been a challenge when printing on non-permeable surfaces, such as, but not limited to fully-cured painted surfaces.

By applying transparent layer 34 over the non-permeable surface coating 32, allowing that to only partially cure and precisely controlling the droplet size deposited, the pigmented layer 36 can be precisely printed with the deposited drops remaining in the desired location to form graphical images on the surface. Applying thin and only partially curing first layer 34 allows for manipulating the surface tension on the printing surface to provide a higher surface tension than a fully cured non-permeable coating would normally provide. This ensures the printed droplets stay at the desired positions for drying to facilitate higher quality inkjet image process generation. The surface tension is related to the level of curing, with surface tension decreasing as curing time increases. At some point of curing, some degradation of the image sharpness is seen due to the lower surface tension allowing for some movement of droplets after deposition by printing. Depending on the application, different levels of sharpness are acceptable, and any partial curing for 24 hours or less can generally ensure sufficient surface tension for printing and sufficient maintaining of droplets in desired locations. The thin application allows for efficient curing of the first layer, and ensures that better appearance.

FIG. 3a shows a schematic embodiment of a print head 40 for use with the method, and FIG. 3b shows a schematic drawing of the bottom of the print head 40. Printer head 40 typically includes an electrical interface 42 for connecting to a power source, one or more fluid interfaces 44 for receiving ink and some sort of mechanical interface for connecting the printhead to the printer or other device from which it is to print. FIG. 3b shows the bottom of printhead 40, which can be referred to as the “nozzle plate.” Nozzle plate 46 includes several rows of nozzles 48a, 48b, 48c and 48d. Different rows of nozzles can be used for depositing different colors of ink. For example, the first jet row may deposit red ink, while the next deposits green and the next blue. The image is formed when very small colored droplets are deposited so close to one another that they appear to cover the surface. It is important that the individual colored droplets do not contact one another, while still wet. Otherwise, they may coalesce forming an unintended color. Alternatively, instead of using separate rows of nozzles on one printhead for separate colors of ink deposition, separate printheads can be used for each separate color.

As print head 40 traverses an area, individual nozzles fire droplets, timed to precisely place their droplets between those deposited by the previous color jets. It is important that the droplet both accurately be placed and that the size of the droplet be precisely controlled and remain consistent. Should variation in the wetting characteristic be observed, coalescence may occur and the image will not be of the desired color. As mentioned prior, in situations where the substrate to be printed on is non-permeable, the wetting of the drop or the ability to maintain the drop position, once it contacts the substrate may be compromised. This is due to the nature of the surface and the resultant interaction between the substrate surface and the surface tension of the deposited wet droplet of ink.

By first depositing a transparent first layer 34 and allowing it to partially but not fully cure, the pigmented layer 36 deposited drops both maintain a more consistent position with respect to other deposited drops and have a reduced, more consistent wetting characteristic. While the first layer 34 must be dry to the touch, application of the inkjet ink drops prior to the first layer 34 being fully cured (particularly in the case for solvent-based inks) results in an image that is more “sharp” and desirable.

When observing a resultant image, if the pigment granules are not at a uniform “depth” on the first layer this can impact hue reproduction. The current method addresses this by controlling the first layer thickness through specific application process of the first layer and ensuring that first layer is dry to the touch but not fully cured (i.e., cured for less than 24 hours) when the second layer is applied. This partial curing of the first layer 34 ensures that the drops deposited thereon are substantially not absorbed by and substantially do not infiltrate the first layer. While some infiltration is possible, the partial curing should ensure that an infiltration rate of less than 0.5 microns is maintained. This ensures a pigment granular depth variation of less than 1 micron, which at that point becomes almost impossible for the human eye to discern, and therefore results in very good hue reproduction.

While the invention has been described with reference to exemplary embodiments, it will be understood by those skilled in the art that various changes may be made and equivalents may be substituted for elements thereof without departing from the scope of the invention. In addition, many modifications may be made to adapt to a particular situation or material to the teachings of the invention without departing from the essential scope thereof. Therefore, it is intended that the invention not be limited to the particular embodiments disclosed, but that the invention will include all embodiments falling within the scope of the appended claims.

1. A method of comprising:
depositing a first layer of a solvent based composition on a non-permeable surface;
partially-curing the first layer; and
printing a second layer of solvent based composition on top of the first layer.

2. The method according to claim 1, wherein the first layer is pigment free.

3. The method according to claim 1, wherein the second layer comprises pigment.

4. The method according to claim 1, wherein the second layer infiltrates the first layer at a rate of 0.5 microns or less.

5. The method according to claim 1, wherein the step of partially curing the first layer comprises curing the first layer at 20-26 degrees C. for less than 24 hours.

6. The method according to claim 5, wherein the step of partially curing the first layer comprises curing the first layer at 20-26 degrees C. for less than 8 hours.

7. The method according to claim 6, wherein the step of partially curing the first layer comprises curing the first layer at 20-26 degrees C. for less than 4 hours.

8. The method according to claim 1, wherein the step of depositing a first layer of solvent based ink on a non-permeable surface comprises applying the first layer with a constant pressure air spray gun.

9. The method according to claim 1, wherein the step of depositing a first layer of solvent based composition on a non-permeable surface comprises applying the first layer with a thickness of 1-5 microns.

10. The method of claim 1, wherein the first layer and the second layer are applied with an automated process.

11. The method of claim 10, wherein the application of the first layer and the second layer are performed with the same device.

12. The method of claim 1, wherein the first layer of solvent based composition is deposited on a coated base surface which has been fully cured.

13. The method of claim 12, wherein the base surface is a metallic surface.

14. The method of claim 1, wherein the step of printing the second layer of solvent based composition on top of the first layer comprises printing the second layer with droplets in the range of 70-85 picolitres.

15. The method of claim 1, and further comprising using a background pulse in the print head and/or a spit process during the printing.

16. The method of claim 1, wherein the first layer comprises a primer with a set solvent and set resin composition, and the second layer comprises a primer of the same solvent and resin composition to the first layer, and further comprises one or more pigments.

17. The method of claim 16, wherein the first layer and the second layer each comprise of solvent based compositions with a solvent weight percent of 65-95.

18. The method of claim 1, wherein the step of printing a second layer of solvent based composition on top of the first layer comprises printing the second layer to be in the range of 1-10 microns.

19. The method of claim 1, wherein the step of depositing a first layer of a solvent based composition on a non-permeable surface comprises depositing the first layer of solvent based composition on a coated non-permeable metallic or composite surface.
